(19) United States
(12) Patent Application Publication
(10) Pub. No.: US 2026/0162123 A1
(43) Pub. Date: Jun. 11, 2026

(54) CUSTOMER CHURN PREDICTION AND MITIGATION FOR NETWORK SERVICE PROVIDERS

(71) Applicant: T-Mobile USA, Inc., Bellevue, WA (US)

(72) Inventor: Murugappan Palaniappan, Issaquah, WA (US)

(21) Appl. No.: 18/977,573

(22) Filed: Dec. 11, 2024

(51) Int. Cl. G06Q 30/01; G06Q 30/0202

(52) U.S. Cl. CPC G06Q 30/01; G06Q 30/0202

(57) ABSTRACT

A computer-implemented method of mitigating customer churn for a telecommunications network service provider includes collecting transaction records from a network provisioning engine and analytical records associated with multiple customers. The analytical records include two or more of provisioning records, call detail records, metered data, and customer service query records. An artificial intelligence (Al) model associates each customer with a sub-classification using the transaction records. For each customer, the Al model determines a predicted churn score using the analytical records and associated sub-classification. If the churn score is above a threshold, the Al model determines a mitigating action to prevent the customer from ending the relationship with the network service provider. The method causes the mitigating action to be performed.

### BACKGROUND

Customer churn, also known as customer attrition, refers to the phenomenon where customers cease their relationship with a service provider or business. In the telecommunications industry, churn occurs when subscribers discontinue their service with a particular network operator. This can have significant financial implications for telecom companies, as acquiring new customers is often more costly than retaining existing ones. Customer churn can be influenced by various factors, including service quality, pricing, competition, and changes in customer needs or preferences.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram of a system for network service management.

FIG. 4 is a block diagram of a system for customer data usage flow management.

FIG. 5 is a block diagram of a system for customer care management.

FIG. 6 illustrates a platform for predicting and mitigating customer churn for a telecommunications network service provider.

FIG. 7 is a flow diagram that illustrates processes for predicting and mitigating customer churn for a telecommunications network service provider.

FIG. 8 is a block diagram that illustrates an example of a computer system in which at least some operations described herein can be implemented.

FIG. 9 is a block diagram that illustrates an example of an artificial intelligence (Al) system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology relates to predicting and mitigating customer churn for telecommunications network service providers. Customer churn refers to customers ending their relationship with a service provider. The technology uses artificial intelligence (AI) and machine learning (ML) models to analyze various data sources, predict the likelihood of customer churn, and determine appropriate actions to prevent customers from leaving the service provider.

Conventional technologies for predicting and mitigating customer churn may rely on limited data sources or simplistic analytical models, which can lead to inaccurate predictions and ineffective retention strategies. These approaches may not account for the complex interplay of factors that influence customer decisions, potentially resulting in missed opportunities to retain valuable subscribers. Additionally, existing systems may struggle to process and analyze large volumes of diverse data in real time, limiting their ability to respond quickly to changing customer behaviors and market conditions.

The present technology addresses these challenges by leveraging artificial intelligence and machine learning models to analyze a wide range of data sources, including transaction records, provisioning data, call detail records, metered usage data, and customer service interactions. This comprehensive approach may enable more accurate predictions of customer churn and more targeted mitigation strategies. By associating customers with sub-classifications and determining personalized churn scores, the system can identify at-risk subscribers with greater precision. Further, the technology's ability to automatically determine and initiate appropriate mitigating actions may allow service providers to respond more quickly and effectively to potential churn situations, potentially improving customer retention rates and maintaining revenue streams.

In one example, a computer-implemented method of mitigating customer churn for a telecommunications network service provider includes collecting transaction records from a network provisioning engine (NPE) associated with multiple customers of the network service provider, where the transaction records describe transactions between the multiple customers and the network service provider, and where the transactions can include transactions associated with one or more services and/or one or more billing systems of the network service provider. The method also involves collecting analytical records associated with the multiple customers, which includes collecting two or more of the following: provisioning records from an NPE catalog describing services and resources required for provisioning network services for the multiple customers, call detail records (CDRs) from multi-mediation (MM) system describing data usage of the multiple customers, metered data from a charging system describing periodic data usage, and customer service query records from a customer service system describing customer service interactions between the network service provider and the multiple customers. By using an artificial intelligence (AI) model and the transaction records, each of the multiple customers is associated with a sub-classification of multiple sub-classifications. For each customer, the AI model determines a predicted churn score using the analytical records and the associated sub-classification, which describes the likelihood of the respective customer ending their relationship with the network service provider. If the churn score is above a threshold churn score, the AI model determines a mitigating action using the analytical records and the associated sub-classification to prevent the customer from ending their relationship with the network service provider, and the mitigating action is then performed.

In another example, a system receives, from a network provisioning engine (NPE), transaction records associated with multiple customers of the network service provider, where the transaction records describe transactions between the multiple customers and the network service provider. The system receives analytical records associated with the multiple customers, which includes two or more of the following: provisioning records describing services and resources required for provisioning network services for the multiple customers, call detail records (CDRs) describing data usage of the multiple customers, metered data describing periodic data usage, and customer service query records describing customer service interactions between the network service provider and the multiple customers. By using an artificial intelligence (AI) model and the transaction records, each of the multiple customers is associated with a sub-classification of multiple sub-classifications. For each customer, the AI model determines a predicted churn score using the analytical records and the associated sub-classification, which describes the likelihood of the respective customer ending their relationship with the network service provider. If the churn score is above a threshold churn score, the AI model determines a mitigating action using the analytical records and the associated sub-classification to prevent the customer from ending their relationship with the network service provider.

In yet another example, a system for mitigating customer churn for a telecommunications network service provider includes at least one hardware processor and at least one non-transitory memory storing instructions, which, when executed by the at least one hardware processor, cause the system to receive, from a network provisioning engine (NPE), transaction records associated with multiple customers of the network service provider, where the transaction records describe transactions between the multiple customers and the network service provider. The system receives analytical records associated with the multiple customers, which includes two or more of the following: provisioning records describing services and resources required for provisioning network services for the multiple customers, call detail records (CDRs) describing data usage of the multiple customers, metered data describing periodic data usage, and customer service query records describing customer service interactions between the network service provider and the multiple customers. By using an artificial intelligence (AI) model and the transaction records, each of the multiple customers is associated with a sub-classification of multiple sub-classifications. For each customer, the AI model determines a predicted churn score using the analytical records and the associated sub-classification, which describes the likelihood of the respective customer ending their relationship with the network service provider. If the churn score is above a threshold churn score, the AI model determines a mitigating action using the analytical records and the associated sub-classification to prevent the customer from ending their relationship with the network service provider.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

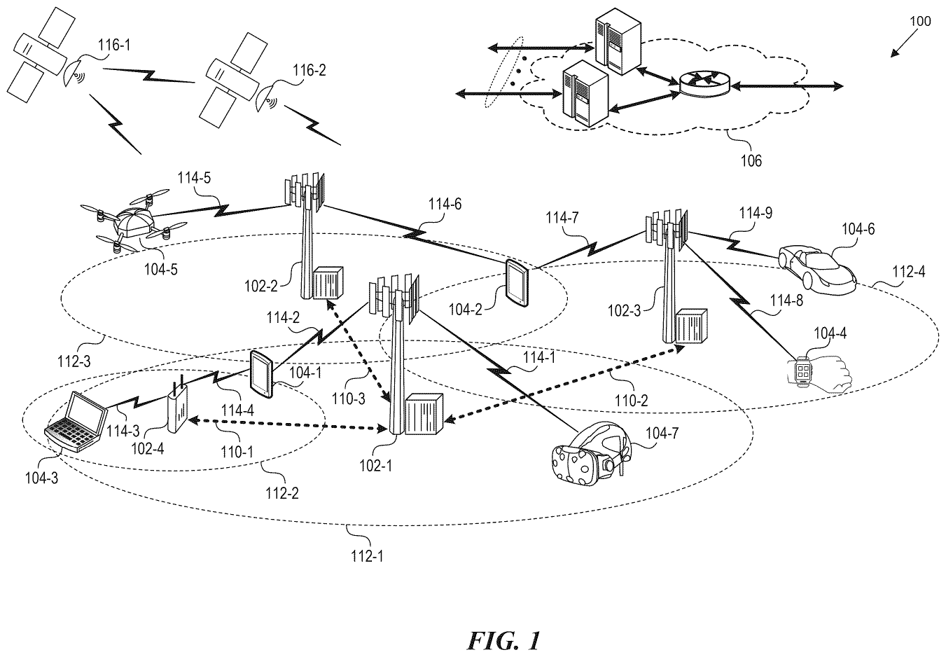

FIG. 1 is a block diagram that illustrates a wireless telecommunications network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNB is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or Time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service requirements and multi-terabits per second data transmission in the 6G and beyond era, such as terabit-per-second backhaul systems, ultrahigh-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low User Plane latency. In yet another example of 6G, the network 100 can implement a converged Wi-Fi and Core architecture to increase and improve indoor coverage.

### 5G Core Network Functions

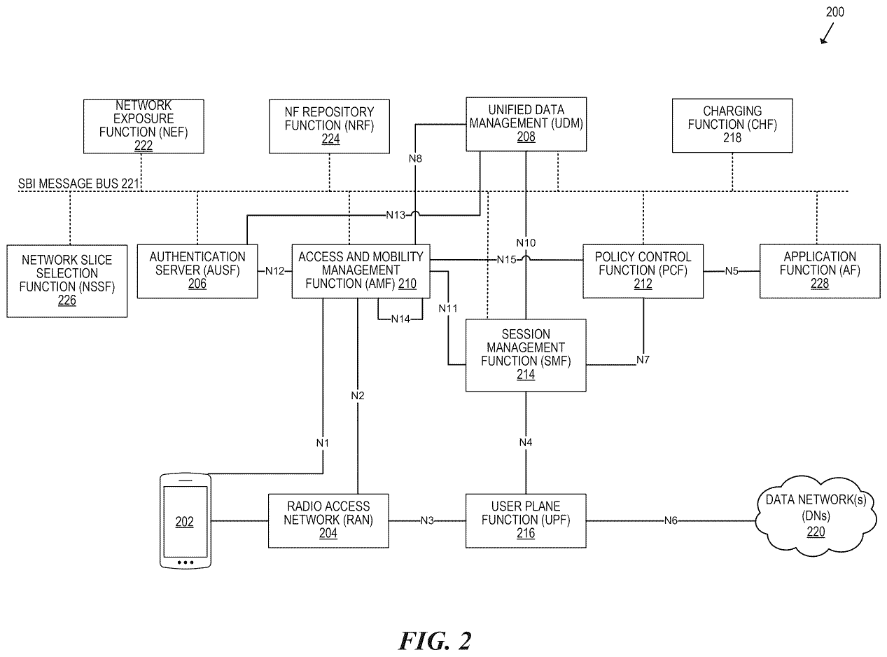

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, a NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS), to provide authentication credentials while being employed by the AMF 210 and SMF 214 to retrieve subscriber data and context.

The PCF 212 can connect with one or more application functions (AFs) 228. The PCF 212 supports a unified policy framework within the 5G infrastructure for governing network behavior. The PCF 212 accesses the subscription information required to make policy decisions from the UDM 208, and then provides the appropriate policy rules to the control plane functions so that they can enforce them. The SCP (not shown) provides a highly distributed multi-access edge compute cloud environment and a single point of entry for a cluster of network functions, once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224, use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework which, along with the more typical QoS and charging rules, includes Network Slice selection, which is regulated by the NSSF 226.

### Customer Churn Prediction and Mitigation

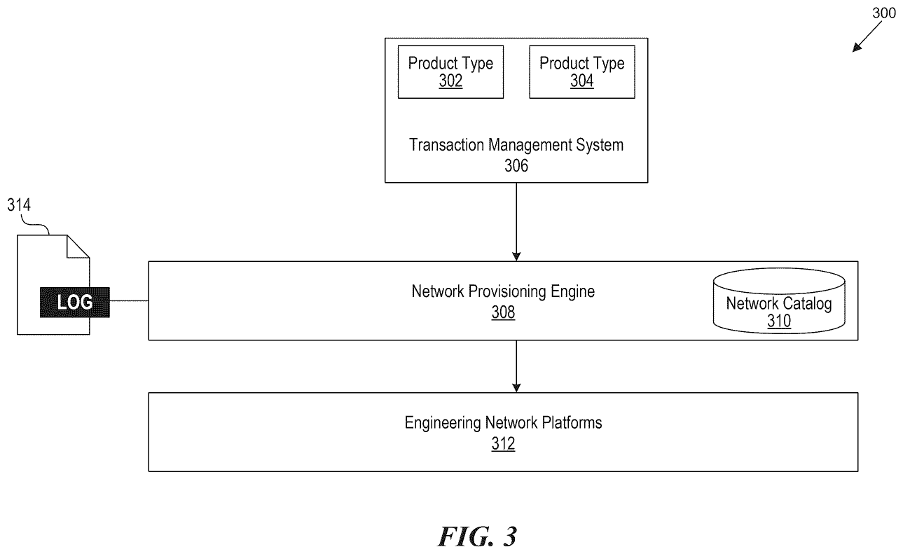

FIG. 3 is a block diagram of a system 300 for network service management. The system 300 includes a network provisioning engine (NPE) 308, an engineering network platforms 312, a network catalog 310, and transaction management system 306.

The NPE 308 is configured to manage network services enabling operation of wireless devices in a network (e.g., the wireless devices 104 in the wireless network 100 in FIG. 1). The network services are provided to wireless devices via the engineering network platforms 312 including network elements (NEs) such as base stations (e.g., the base stations 102 in FIG. 1). In some implementations, the NEs can include routers, switches, gateways, firewalls, and other equipment that facilitate wireless communication and data transfer. The network elements (or network nodes) of the engineering network platforms 312 can include one or more of the functions described with respect to FIG. 2 as well as other network functions or elements. For example, the engineering network platforms 312 can include the CS (Charging System) configured to track of voice, text, data usage and monetary rating, for, for example, International Long Distance Calls; IAM (Identity Access Management) configured to track subscriber authentication and authorization of what they can access; UPG (Universal Provisioning Gateway) configured to provision to Home Location Register (HLR), Home Subscriber Server (HSS), and Unified Data Management (UDM) where HLR, HSS, and UDM are configured to store 3G, 4G, and 5G data and are configured to authenticate the registration of a subscriber and what they can access in the network; NEF (Network Exposure Function) configured to provide secure access to the network. It enables quick provisioning and query access to the network; EIR/EIRNSR (Equipment Identity Register) configured to maintain a record of the all the mobile stations (MS) that are allowed in a network as well as a database of all equipment that is banned, (e.g. because it is lost or stolen) where EIRNSR is an extension that stores non-subscriber-based information such as description of a device; IPM (IP address provisioning module) configured to provide static IP address to a device usually by talking to a Radius server; Tibco CB (Middleware callback) configured to provision particular events where callback is done to notify the completion of a provisioning event; NAP (Nokia Application Publisher) configured to track of all billing SOCs, features, and provide calls to third-party applications integrated with the network to know that a subscription has changed; MOBI (Mobileum platform) configured to make roaming steering decisions based on certain provisioning events; UWSG/CDB/VMAS (Universal Web Services Gateway) configured to receive provisioning events from NPE and then in turn provisions Customer Database for messaging and Voicemail Access; OTA (Over the Air) configured to maintain the mapping between ICCID and SIM and sends any SIM updates to the devices; Epoch (Entitlement and Apple Notifications Middleware) configured to provision events from NPE that in turn provisions to the entitlement server that says what each user is entitled to access in the network and sends notifications to Apple devices; and/or AMF (Access and Mobility Function) configured to control plane network functions in the 5G network; SMF (Session Management Function) which is a core network element in the 5G network that manages sessions between user devices and the network.

A network service product (or a modification to an existing network service product) can be requested by the transaction management system 306 (e.g., a billing management system) (e.g., through an Application Programming Interface (API)) as an activation provision request. For example, the transaction management system 306 sends a request for a new product to the NPE 308. The new product is defined by customer-facing services (CFSs) (also called customer-facing service (CFS) features). The CFSs define a variety of functionalities and can be specific to product types (e.g., product types 302 and 304) and/or billing systems. Different product types can be associated with different billing systems. A product type can refer to, for example, a pre-paid versus postpaid network service, limited data usage plans versus unlimited data plans, or plans allowing free roaming through partners versus plans not allowing free roaming through partners. The network catalog 310 (e.g., a network provisioning catalog) is a repository that contains configurations, resources, and information required to provision network services to customers. All transactions between a customer and the network service provider are initiated through the transaction management system 306 and facilitated by the NPE 308. All information regarding these transactions is collected and stored to a transaction records log 314. For example, the NPE 308 transmits requests associated with all the transactions received from the transaction management system 306 to a database or data storage including the transaction records log 314. Examples of transactions associated with voice, text message (e.g., short message service (SMS) messages), and data services include, but are not limited to, initiation of new subscriptions, upgrades or downgrades to existing subscriptions, add-on services to subscriptions, changing between different subscriptions between same type of plan or between different types of plan (e.g., a customer changing between prepaid and postpaid service products), ending subscriptions or plans, and changes in geographical location of a customer.

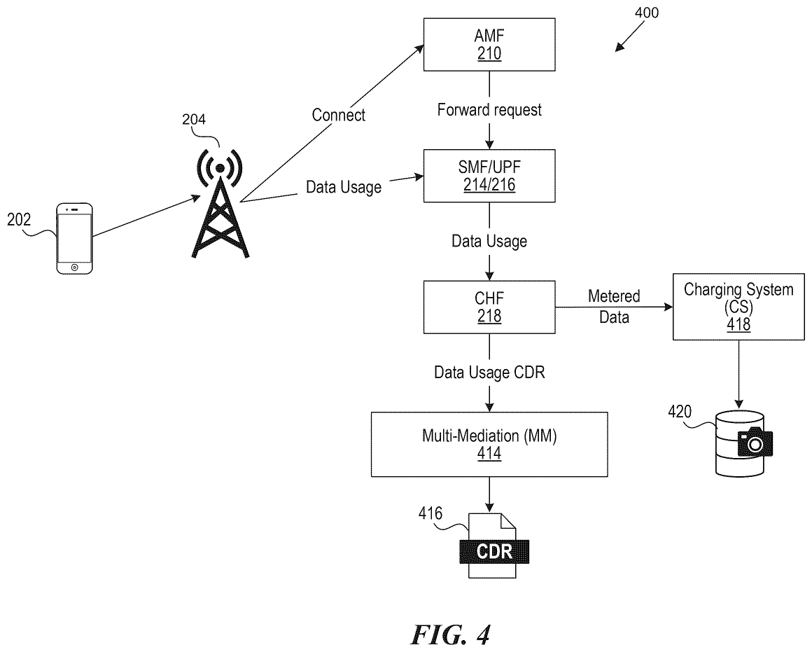

FIG. 4 is a block diagram of a system 400 for customer data usage flow management. Specifically, FIG. 4 illustrates how data usage of user devices (e.g., the user device 202 on communication with the system 400 via the RAN 204) is monitored and collected. The system 400 includes the AMF 210, the SMF 214 and/or UPF 216 and CHF 218 described with respect to FIG. 2. The CHF 218 is configured to monitor, manage, and bill for the usage of network resources and services. A multi-mediation system (MM) 414 (e.g., an Ericsson 414 ediation (EMM) system) is configured to receive call detail records (CDRs) 416 describing data usage of user devices from the CHF 218. An MM system is configured to collect, process, and consolidate CDRs to enable real-time billing, analytics, and reporting for telecommunications operators. The CDRs 416 can include information about telecommunication interactions (e.g., voice calls, text messages). The information can include, for example, call initiator number, call receiver number, call start and end times, call durations, call types (e.g., voice call, text message, data session), call status (e.g., busy, failed, answered), service provider information, or cell site information. A charging system (CS) 418 is configured to receive metered data from the CHF 218 which is stored as metered data 420 (e.g., a daily snapshot of the metered data collected by the CH 418). The metered data 420 describes periodic data usage by user devices. The metered data 420 can be used for monitoring customers who have data limits on their subscription plans or whose plans paid per usage. The metered data 420 can include, for example, description of the amount of data used in a past period (e.g., monthly, weekly, daily, hourly) for voice calls, text messages, and data.

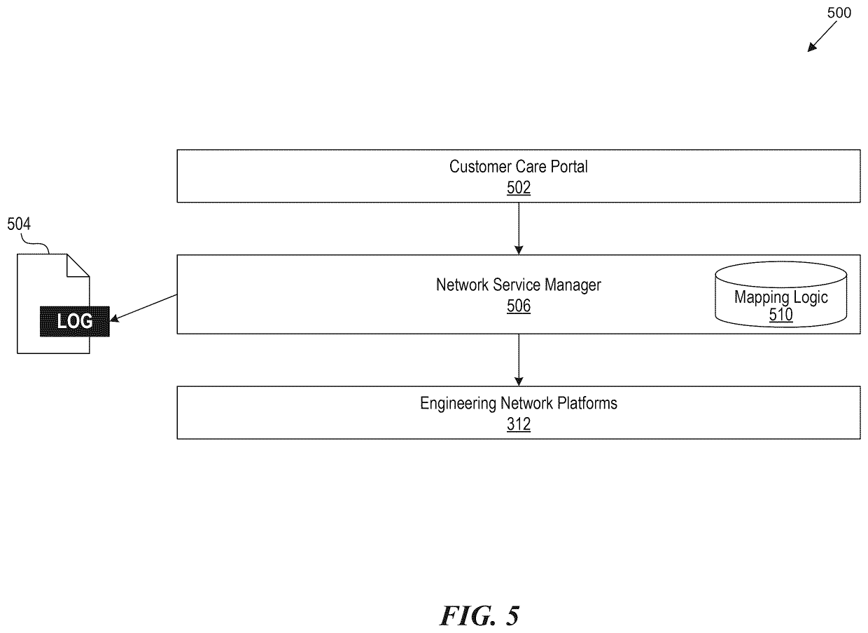

FIG. 5 is a block diagram of a system 500 for customer care management. The system 500 includes a customer care portal 502, a network service manager 506 and a mapping logic 510. The customer care portal 502 is configured to interact with the customer. For example, the customer care portal 502 can receive questions, comments, inquiries, etc. from customers via emails, voice calls, chat messages, text messages, or website or application interfaces. The customer interactions can include, for example, customers inquiring about new or upgraded services or devices, making complaints (e.g., about pricing, network performance, or device performance), inquiries about pricing, or asking help for technical problems. The customer care portal 502 can transmit the interactions to the network service manager 506 as queries. The network service manager 506 is configured to manage the customer care queries and, for example, communicate the queries to the mapping logic 510 which is configured to, for example, categorize the queries, identify customer needs, and identify and resolve any incidents. The network service manager 506 can communicate the queries to the engineering network platforms 312 described with respect to FIG. 3. Further, the network service manager 506 is configured to collect and store all information about customer service interactions between the network service provider and the customers to customer care log 504. The information can include, for example, information about the type of interaction and possible identified solution for interaction and be associated with a customer's phone number or customer's profile.

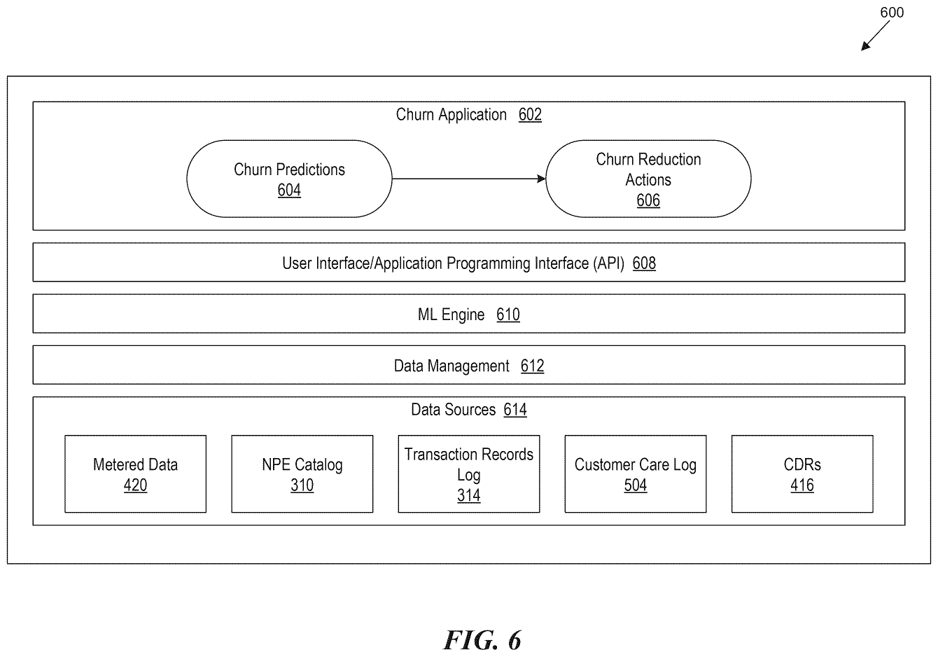

FIG. 6 illustrates a platform 600 for predicting and mitigating customer churn for a telecommunications network service provider. The platform includes a churn application 602, a user interface and application programing interface (API) 608, an ML (or an AI) engine 610, a data management system 612 and data sources 614 (e.g., including the metered data 420, NPE catalog 310, transaction records 314, customer care log 504, and CDRs 416 described with respect to FIGS. 3-5). The data management system 612 is configured to receive the different data from data sources 614 and feed the data (all or a portion of) to the ML engine 610. The ML engine 610 is trained to provide churn predictions 604 describing churn likelihood for different customers based on the data and identify churn reduction actions 606 (e.g., actions to prevent or mitigate churn). The churn predictions 604 and churn reduction actions 606 are provided to a user via a user interface of the churn application 602 that is facilitated by the user interface and API 608.

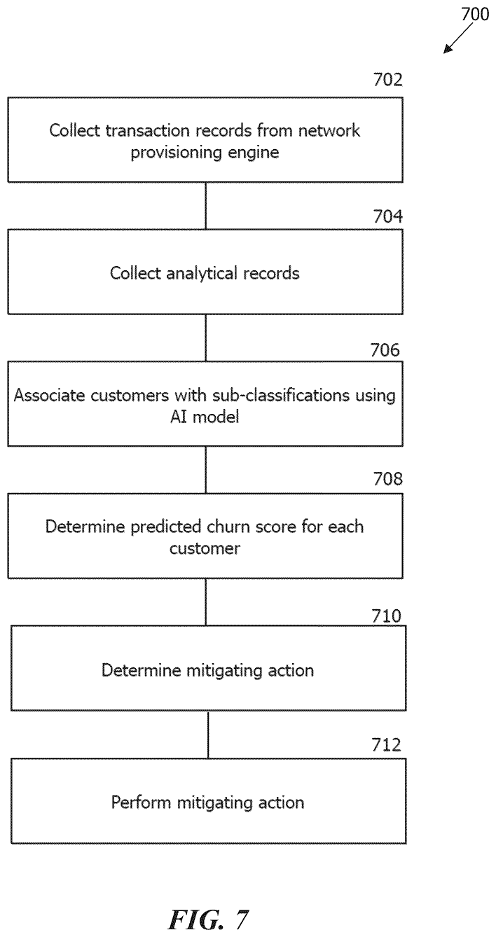

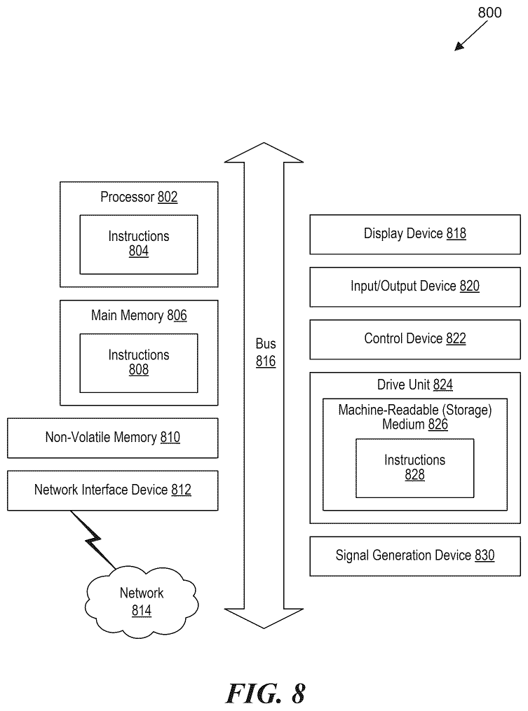

FIG. 7 is a flow diagram that illustrates processes 700 for predicting and mitigating customer churn for a telecommunications network service provider. The processes 700 can be performed by a system (e.g., the platform 600 in FIG. 6) associated with a telecommunications network service provider (e.g., a service provider of the network 100 in FIG. 1). The system can include at least one hardware processor and at least one non-transitory memory storing instructions (e.g., a computer system 800 described with respect to FIG. 8). When the instructions are executed by the at least one hardware processor, the system performs the processes 700.

The processes 700 are configured to predict and mitigate customer churn for telecommunications network service. Conventional methods often rely on limited data and simplistic models which can lead to inaccurate predictions and ineffective mitigation strategies. In contrast, the processes 700 include receiving and analyzing a several data sources, including transaction records and customer service interaction records, to provide more accurate churn predictions and targeted mitigation strategies. The processes 700 include assigning churn scores for customers and initiating appropriate mitigating actions automatically. The processes 700 can decrease customer churn and maintain revenue streams for network service providers.

At 702, the system collects, from a network provisioning engine (NPE) (e.g., the NPE 308 in FIG. 3), transaction records (e.g., the transaction records log 314 in FIG. 3) associated with multiple customers of the network service provider. The transaction records describe transactions between the multiple customers and the network service provider. The transactions can include transactions associated with one or more services (e.g., the product types 302 and 304 in FIG. 3) and/or one or more billing systems of the network service provider.

At 704, the system collects analytical records associated with the multiple customers. The collecting comprises collecting two or more of: provisioning records from an NPE catalog (e.g., the network catalog 310 in FIG. 3) describing services and resources required for provisioning network services for the multiple customers, CDRs from multi-mediation (MM) system (e.g., the CDRs 416 in FIG. 4) describing data usage of the multiple customers, metered data from a charging system (e.g., the metered data 420 in FIG. 4) describing periodic data usage, and customer service query records from a customer service system (e.g., the customer care log 504) describing customer service interactions between the network service provider and the multiple customers.

At 706, the system associates, by an artificial intelligence (AI) model (e.g., the ML engine 610 in FIG. 6) using the transaction records, each of the multiple customers with a sub-classification of multiple sub-classifications. In some implementations, the multiple sub-classifications can be associated with different product types (e.g., the product types 302 and 304 in FIG. 3) provided by the network service provider. In some implementations, the multiple sub-classifications can be associated with different geographical regions (e.g., cities, counties, states, or regions defined by one or more of the coverage areas 112-1 through 112-4). Examples of criteria to be associated with a sub-classification include geographical locations, rate plans, service product types, and add-ons (e.g., add on services such as roaming data plans, voicemail services, additional devices). In some implementations, a sub-classification includes an importance of a customer. For example, a higher importance is given to customers who have been with network service providers for a long period of time (e.g., years) than for customers who have been with the network service provider for a shorter period of time.

At 708, for each of the multiple customers, the system determines, by the AI model using the analytical records and an associated sub-classification, a predicted churn score describing a likelihood of the respective customer to end customer relationship with the network service provider.

Responsive to a determination that the churn score is above (or below) a threshold churn score, at 710 the system determines, by the AI model using the analytical records and an associated sub-classification, a mitigating action for preventing the customer from ending the customer relationship with the network service provider. At 712, the system causes the mitigating action to be performed.

In some implementations, the mitigating action can include one or more of offering a lower price, offering an upgrade to an existing network service product, offering a new network service product, suggesting a purchase of an upgraded wireless device, offering to change between pre-paid and post-paid plans, providing, to a marketing team of the network service provider, information regarding determined churn and suggested actions such as promotion and marketing campaigns, customer targeting, etc. In some implementations, the system can take into consideration public information available regarding competitors'products (e.g., pricing and product types) when identifying the mitigating actions.

In some implementations, responsive to the determination that the churn score is above a threshold churn score, the system identifies, by the AI model using the analytical records and an associated sub-classification, one or more churn factors causing the likelihood of the respective customer to end customer relationship with the network service provider. The mitigating action can be further determined based on the one or more churn factors. In some implementations, the one or more churn factors can be selected from a price, a network performance problem, a frequency of network outages, a geographical location of a customer, a reach of periodic data limit, a type of a customer's wireless device, or an age of a customer's wireless device.

The one or more churn factors can also be selected from a frequency of customers doing a rate plan change; customers moving between MVNOs within wholesale biller; customers moving between billers within the network service provider, for example, postpaid to prepaid (intra-port) or moving out from the network service provider; frequency of customer care representative doing an update on a network node for customers or making frequent queries on behalf of the customers; length of time customers have been on a billing system indicating customer satisfaction; customers being suspended and their reason for suspension being, for example, non-payment; usage pattern changes, for example, customers having a 2 GB plan and consistently exceeds 2 GB usage that may result in throttled speeds; customers'location changes shown in CDRs (e.g., moving from good coverage region to poor coverage region); and/or frequent session termination request (STR) generated possibly indicating spotty coverage.

In some implementations, the system identifies, for a subset of the multiple customers that are associated with a particular sub-classification, a trend of an increased number of customers having the predicted churn score above the threshold churn score over a period of time. The particular sub-classification can be associated with a particular network service product of the network service provider. The system can modify the particular network service product in response to the identified trend. For example, the system identifies a trend that customers living in or visiting certain geographic areas, using a particular product or product type, experiencing network congestion at certain frequency or at certain time of a day, or using particular types of devices (e.g., AR/VR devices versus mobile phones) have increased churn scores. The system can take mitigating action prior to significant amount of churn taking place.

As an example, the system identifies, by the AI model for a subset of the multiple customers that are associated with a particular sub-classification, a trend of an increased number of customers having the predicted churn score above the threshold churn score. The sub-classification can be associated with a particular network service product with a periodic data usage limit. The system can identify, by the AI model, that the trend is at least partially due to customers going over the periodic data usage limits. The determined mitigating action can include increasing the periodic data usage limit for the particular network service product.

As another example, the system identifies, by the AI model for a subset of the multiple customers that are associated with a particular sub-classification, a trend of an increased number of customers having the predicted churn score above the threshold churn score. The sub-classification can be associated with a particular geographical region. The system identifies, by the AI model, that the trend is at least partially due to customers experiencing network congestion. The determined mitigating action can include increasing network capacity in the particular geographical region.

As yet another example, the system identifies, by the AI model for a subset of the multiple customers that are associated with a particular sub-classification, a trend of an increased number of customers having the predicted churn score above the threshold churn score. The sub-classification can be associated with a particular network service product. The system identifies, by the AI model, that the trend is at least partially due a competitor's comparative product having a lower price. The determined mitigating action can include reducing the price of the particular network service product.

In some implementations, the system continuously trains the AI model with the collected transaction records and analytical records and an outcome identifying whether the determined mitigation is a mitigating action for preventing the customer from ending the customer relationship with the network service provider.

### Computer System

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, video display device 818, an input/output device 820, a control device 822 (e.g., keyboard and pointing device), a drive unit 824 that includes a storage medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computing system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 800. In some implementation, the computer system 800 can be an embedded computer system, a system-on-chip (SOC), a single-board computer system (SBC) or a distributed system such as a mesh of computer systems or include one or more cloud components in one or more networks. Where appropriate, one or more computer systems 800 can perform operations in real time, near real time, or in batch mode.

The network interface device 812 enables the computing system 800 to mediate data in a network 814 with an entity that is external to the computing system 800 through any communication protocol supported by the computing system 800 and the external entity. Examples of the network interface device 812 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable (storage) medium 826 can include any medium that is capable of storing, encoding, or carrying a set of instructions for execution by the computing system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computing system 800 to perform operations to execute elements involving the various aspects of the disclosure.

### AI System

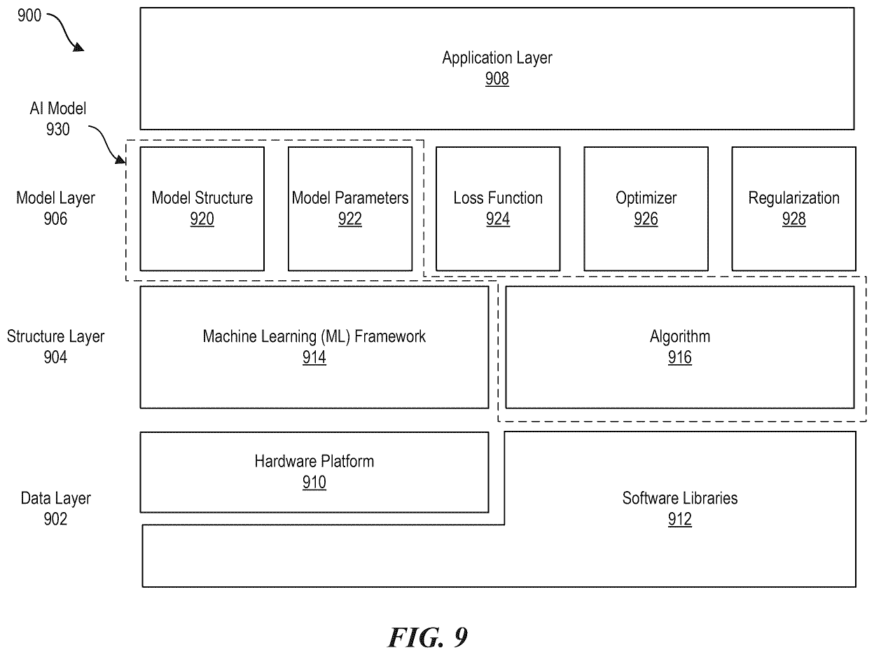

FIG. 9 is a block diagram that illustrates an example of an AI system 900 in which at least some operations described herein can be implemented. As shown, the AI system 900 can include a set of layers, which conceptually organize elements within an example network topology for the AI system's architecture to implement a particular AI model 930. Generally, an AI model 930 is a computer-executable program implemented by the AI system 900 that analyzes data to make predictions. Information can pass through each layer of the AI system 900 to generate outputs for the AI model 930. The layers can include a data layer 902, a structure layer 904, a model layer 906, and an application layer 908. The algorithm 916 of the structure layer 904 and the model structure 920 and model parameters 922 of the model layer 906 together form the example AI model 930. The optimizer 926, loss function engine 924, and regularization engine 928 work to refine and optimize the AI model 930, and the data layer 902 provides resources and support for the application of the AI model 930 by the application layer 908.

The data layer 902 acts as the foundation of the AI system 900 by preparing data for the AI model 930. As shown, the data layer 902 can include two sub-layers: a hardware platform 910 and one or more software libraries 912. The hardware platform 910 can be designed to perform operations for the AI model 930 and include computing resources for storage, memory, logic, and networking, such as the resources described in relation to FIG. 5. The hardware platform 910 can process amounts of data using one or more servers. The servers can perform backend operations such as matrix calculations, parallel calculations, machine learning (ML) training, and the like. Examples of servers used by the hardware platform 910 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 910 can include Infrastructure as a Service (IaaS) resources, which are computing resources (e.g., servers, memory, etc.), offered by a cloud services provider. The hardware platform 910 can also include computer memory for storing data about the AI model 930, application of the AI model 930, and training data for the AI model 930. The computer memory can be a form of random-access memory (RAM), such as dynamic RAM, static RAM, and non-volatile RAM.

The software libraries 912 can be thought of as suites of data and programming code, including executables, used to control the computing resources of the hardware platform 910. The programming code can include low-level primitives (e.g., fundamental language elements) that form the foundation of one or more low-level programming languages, such that servers of the hardware platform 910 can use the low-level primitives to carry out specific operations. The low-level programming languages do not require much, if any, abstraction from a computing resource's instruction set architecture, allowing them to run quickly with a small memory footprint.

The structure layer 904 can include an ML framework 914 and an algorithm 916. The ML framework 914 can be thought of as an interface, library, or tool that allows users to build and deploy the AI model 930. The ML framework 914 can include an open-source library, an Application Programming Interface (API), a gradient-boosting library, an ensemble method, and/or a deep learning toolkit that work with the layers of the AI system to facilitate the development of the AI model 930. For example, the ML framework 914 can distribute processes for the application or training of the AI model 930 across multiple resources in the hardware platform 910. The ML framework 914 can also include a set of pre-built components that have the functionality to implement and train the AI model 930 and allow users to use pre-built functions and classes to construct and train the AI model 930. Thus, the ML framework 914 can be used to facilitate data engineering, development, hyperparameter tuning, testing, and training for the AI model 930.

The algorithm 916 can be an organized set of computer-executable operations used to generate output data from a set of input data and can be described using pseudocode. The algorithm 916 can include complex code that allows the computing resources to learn from new input data and create new/modified outputs based on what was learned. In some implementations, the algorithm 916 can build the AI model 930 through being trained while running computing resources of the hardware platform 910. This training allows the algorithm 916 to make predictions or decisions without being explicitly programmed to do so. Once trained, the algorithm 916 can run at the computing resources as part of the AI model 930 to make predictions or decisions, improve computing resource performance, or perform tasks. The algorithm 916 can be trained using supervised learning, unsupervised learning, semi-supervised learning, and/or reinforcement learning.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A computer-implemented method of mitigating customer churn for a telecommunications network service provider associated with a telecommunications network, the method comprising:
collecting, from a network provisioning engine (NPE), transaction records associated with multiple customers of the network service provider,
wherein the transaction records describe transactions between the multiple customers and the network service provider, and
wherein the transactions can include transactions associated with one or more services and/or one or more billing systems of the network service provider;
collecting analytical records associated with the multiple customers, the collecting comprising collecting:
provisioning records from an NPE catalog describing services and resources required for provisioning network services for the multiple customers,
call detail records (CDRs), from multi-mediation (MM) system, describing data usage of the multiple customers, the CDRs including location information associated with the multiple customers,
metered data, from a charging system, describing periodic data usage, and
customer service query records, from a customer service system, describing customer service interactions between the network service provider and the multiple customers;
associating, by an artificial intelligence (AI) model using the transaction records, each of the multiple customers with a sub-classification of multiple sub-classifications,
wherein the sub-classification includes an association with a particular network coverage area of the telecommunications network;
for particular customer of the multiple customers,
determining, by the AI model using the analytical records and an associated sub-classification, a predicted churn score describing a likelihood of the particular customer to end customer relationship with the network service provider; and
responsive to a determination that the churn score is above a threshold churn score,
determining, by the AI model using the analytical records and the associated sub-classification, whether the churn score is above a threshold churn score due to network congestion associated with the particular network coverage area;
responsive to a determination that the churn score is above the threshold churn score due to network congestion associated with the particular network coverage area,
determining, by the AI model using the analytical records and the associated sub-classification, a mitigating action for preventing the particular customer from ending the customer relationship with the network service provider, the mitigating action including increasing network capacity for the particular customer by providing network slicing for the particular customer; and
causing the NPE to provide the network slicing for the particular customer by:
transmitting a connection request to an access and mobility function (AMF) portion of the telecommunications network, and
causing the AMF portion to establish a slice session for the customer.

2. The method of claim 1,
wherein the mitigating action further includes one or more of offering a lower price, offering an upgrade to an existing network service product, offering a new network service product, and suggesting a purchase of an upgraded wireless device.

3. The method of claim 1, further comprising:
responsive to the determination that the churn score is above the threshold churn score,
identifying, by the AI model using the analytical records and an associated sub-classification, one or more additional churn factors causing the likelihood of the respective-particular customer to end customer relationship with the network service provider,
wherein the mitigating action is further determined based on the one or more churn factors.

4. The method of claim 1, further comprising:
responsive to the determination that the churn score is above a the threshold churn score,
identifying, by the AI model using the analytical records and the associated sub-classification, one or more additional churn factors causing the likelihood of the particular customer to end customer relationship with the network service provider,
wherein the one or more churn factors are selected from a price, a network performance problem, a frequency of network outages, a geographical location of a customer, a reach of periodic data limit, a type of a customer's wireless device, or an age of a customer's wireless device.

5. The method of claim 1, further comprising:
identifying, for a subset of the multiple customers that are associated with a particular sub-classification, a trend of an increased number of customers having the predicted churn score above the threshold churn score over a period of time,
wherein the particular sub-classification is associated with a particular network service product of the network service provider; and
modifying the particular network service product in response to the identified trend.

6. The method of claim 1,
wherein the multiple sub-classifications are associated with different product types provided by the network service provider.

7. The method of claim 1,
wherein the multiple sub-classifications are associated with different geographical regions.

8. The method of claim 1, further comprising:
identifying, by the AI model for a subset of the multiple customers that are associated with a particular sub-classification, a trend of an increased number of customers having the predicted churn score above the threshold churn score,
wherein the sub-classification is associated with a particular network service product with a periodic data usage limit; and
identifying, by the AI model, that the trend is at least partially due to customers going over the periodic data usage limits,
wherein the determined mitigating action includes increasing the periodic data usage limit for the particular network service product.

9. The method of claim 1, further comprising:
identifying, by the AI model for a subset of the multiple customers that are associated with a particular sub-classification, a trend of an increased number of customers having the predicted churn score above the threshold churn score,
wherein the sub-classification is associated with a particular geographical region; and
identifying, by the AI model, that the trend is at least partially due to customers experiencing network congestion,
wherein the determined mitigating action includes increasing network capacity in the particular geographical region.

10. The method of claim 1, further comprising:
identifying, by the AI model for a subset of the multiple customers that are associated with a particular sub-classification, a trend of an increased number of customers having the predicted churn score above the threshold churn score,
wherein the sub-classification is associated with a particular network service product; and
identifying, by the AI model, that the trend is at least partially due to a competitor's comparative product having a lower price,
wherein the determined mitigating action includes reducing price of the particular network service product.

11. The method of claim 1, further comprising:
continuously training the AI model with the collected transaction records and analytical records and an outcome identifying whether the determined mitigation is a mitigating action for preventing the customer from ending the customer relationship with the network service provider. (Currently Amended) A non-transitory, computer-readable storage medium comprising instructions recorded thereon, wherein the instructions, when executed by at least one data processor of a system for mitigating customer churn for a telecommunications network service provider associated with a telecommunications network, cause the system to:
receive, from a network provisioning engine (NPE), transaction records associated with multiple customers of the network service provider,
wherein the transaction records describe transactions between the multiple customers and the network service provider;
receive analytical records associated with the multiple customers, the analytical records comprising:
provisioning records describing services and resources required for provisioning network services for the multiple customers,
call detail records (CDRs) describing data usage of the multiple customers,
metered data describing periodic data usage, the CDRs including location information associated with the multiple customers, and
customer service query records describing customer service interactions between the network service provider and the multiple customers;
associate, by an artificial intelligence (AI) model using the transaction records, each of the multiple customers with a sub-classification of multiple sub-classifications, wherein the sub-classification includes an association with particular network coverage area of the telecommunications network;
for a particular customer of the multiple customers,
determine, by the AI model using the analytical records and an associated sub-classification, a predicted churn score describing a likelihood of the particular customer to end customer relationship with the network service provider;
responsive to a determination that the churn score is above a threshold churn score,
determine, by the AI model using the analytical records and the associated sub-classification, whether the churn score is above a threshold churn score due to network congestion associated with the particular network coverage area;
responsive to a determination that the churn score is above the threshold churn score due to network congestion associated with the particular network coverage area:
determine, by the AI model using the analytical records and the associated sub-classification, a mitigating action for preventing the particular customer from ending the customer relationship with the network service provider, the mitigating action including increasing network capacity for the particular customer by providing network slicing for the particular customer; and
cause the NPE to provide the network slicing for the particular customer by:
transmitting a connection request to an access and mobility function (AMF) portion of the telecommunications network, and
causing the AMF portion to establish a slice session for the customer.

13. The non-transitory, computer-readable storage medium of claim 12,
wherein the mitigating action further includes one or more of offering a lower price, offering an upgrade to an existing network service product, offering a new network service product, and suggesting a purchase of an upgraded wireless device.

14. The non-transitory, computer-readable storage medium of claim 12, wherein the system is further caused to:
responsive to the determination that the churn score is above a threshold churn score,
identify, by the AI model using the analytical records and an associated sub-classification, one or more additional churn factors causing the likelihood of the particular customer to end customer relationship with the network service provider,
wherein the mitigating action is further determined based on the one or more additional churn factors.

15. The non-transitory, computer-readable storage medium of claim 12, wherein the system is further caused to:
responsive to the determination that the churn score is above a threshold churn score,
identify, by the AI model using the analytical records and the associated sub-classification, one or more additional churn factors causing the likelihood of the particular customer to end customer relationship with the network service provider,
wherein the one or more additional churn factors are selected from a price, a network performance problem, a frequency of network outages, a geographical location of a customer, a reach of periodic data limit, a type of a customer's wireless device, or an age of a customer's wireless device.

16. The non-transitory, computer-readable storage medium of claim 12, further comprising:
identifying, for a subset of the multiple customers that are associated with a particular sub-classification, a trend of an increased number of customers having the predicted churn score above the threshold churn score over a period of time,
wherein the particular sub-classification is associated with a particular network service product of the network service provider; and
modifying the particular network service product in response to the identified trend.

17. A system for mitigating customer churn for a telecommunications network service provider associated with a telecommunications network, the system comprising:
at least one hardware processor; and
at least one non-transitory memory storing instructions, which, when executed by the at least one hardware processor, cause the system to:
receive, from a network provisioning engine (NPE), transaction records associated with multiple customers of the network service provider,
wherein the transaction records describe transactions between the multiple customers and the network service provider;
receive analytical records associated with the multiple customers, the analytical records comprising:
provisioning records describing services and resources required for provisioning network services for the multiple customers,
call detail records (CDRs) describing data usage of the multiple customers,
metered data describing periodic data usage, the CDRs including location information associated with the multiple customers, and
customer service query records describing customer service interactions between the network service provider and the multiple customers;
associate, by an artificial intelligence (AI) model using the transaction records, each of the multiple customers with a sub-classification of multiple sub-classifications,
wherein the sub-classification includes an association with a particular network coverage area of the telecommunications network;
for particular customer of the multiple customers,
determine, by the AI model using the analytical records and an associated sub-classification, a predicted churn score describing a likelihood of the particular customer to end customer relationship with the network service provider; and
responsive to a determination that the churn score is above a threshold churn score,
determine, by the AI model using the analytical records and the associated sub-classification, whether the churn score is above a threshold churn score due to network congestion associated with the particular network coverage area;
responsive to a determination that the churn score is above the threshold churn score due to network congestion associated with the particular network coverage area,
determine, by the AI model using the analytical records and an associated sub-classification, a mitigating action for preventing the particular customer from ending the customer relationship with the network service provider, the mitigating action including increasing network capacity for the particular customer by providing network slicing for the particular customer; and
cause the NPE to provide the network slicing for the particular customer by:
transmitting a connection request to an access and mobility function (AMF) portion of the telecommunications network, and
causing the AMF portion to establish a slice session for the customer.

18. The system of claim 17,
wherein the mitigating action further includes one or more of offering a lower price, offering an upgrade to an existing network service product, offering a new network service product, and suggesting a purchase of an upgraded wireless device.

19. The system of claim 17, wherein the system is further caused to:
responsive to the determination that the churn score is above a threshold churn score,
identify, by the AI model using the analytical records and an associated sub-classification, one or more additional churn factors causing the likelihood of the particular customer to end customer relationship with the network service provider,
wherein the mitigating action is further determined based on the one or more additional churn factors.

20. The system of claim 17, wherein the system is further caused to:
responsive to the determination that the churn score is above a threshold churn score,
identify, by the AI model using the analytical records and the associated sub-classification, one or more additional churn factors causing the likelihood of the particular customer to end customer relationship with the network service provider,
wherein the one or more churn additional factors are selected from a price, a network performance problem, a frequency of network outages, a geographical location of a customer, a reach of periodic data limit, a type of a customer's wireless device, or an age of a customer's wireless device.
